(19) United States
(12) Patent Application Publication
(10) Pub. No.: US 2017/0009932 A1
(43) Pub. Date: Jan. 12, 2017

(54) AUTOMATIC EMERGENCY LIFTING OR LOWERING SYSTEM FOR OPERATIONAL DEPLOYMENT FACILITY

(71) Applicant: ILSEONG ENG CO., LTD., Busan (KR)

(72) Inventor: Se Man OH, Busan (KR)

(21) Appl. No.: 15/202,460

(22) Filed: Jul. 5, 2016

(30) Foreign Application Priority Data
Jul. 8, 2015 (KR) 10-2015-0096862

(51) Int. Cl. F16M 11/04; G01D 11/30; F16M 11/18

(52) U.S. Cl. CPC F16M 11/046; F16M 11/18; G01D 11/30

(57) ABSTRACT

There is provided an automatic emergency lifting or lowering system for an operational deployment facility with a long hoisting distance, wherein the operational deployment facility has a platform and a trace-tracking device hidden in the platform, wherein the trace-tracking device is configured to track a trace of a moving object including a missile and a bomb, wherein the automatic emergency lifting or lowering system comprises; at least one hoist apparatus configured to lower or lift the trace-tracking device; and at least one hydraulic motor coupled to the hoist apparatus to drive the hoist apparatus in a lifting or lowering mode.

### CROSS-REFERENCE TO RELATED APPLICATION

This application claims the benefit of Korea Patent Application No. 10-2015-0096862 filed on 8 Jul. 2015, the entire content of which is incorporated herein by reference for all purposes as if fully set forth herein.

### BACKGROUND

Field of the Present Disclosure

The present disclosure relates to an automatic emergency lifting or lowering system for an operational deployment facility with a long hoisting distance.

Discussion of the Related Art

Generally, an operational deployment facility may act to sense the attack of the enemy. The operational deployment facility may include a trace-tracking device configured to track a trace of a moving object including a missile and a bomb, etc. This may lead to an identification of the source location of the missile, bomb, etc. of the enemy. Thus, the source location of the missile, bomb, etc. of the enemy may be destructed by a counter-bombing or missile firing.

The trace-tracking device may be lifted or lowered to be brought into a tacking mode or hidden mode. In the tracking mode, the trace-tracking device may track a trace of a moving object including a missile and a bomb, etc. For this, the trace-tracking device may move up. In the hidden mode, the trace-tracking device may be hidden in the platform to prevent the trace-tracking device from being sensed by the enemy. For this, the operational deployment facility may include a lifting or lowering apparatus to lift or lower the trace-tracking device.

The conventional lifting or lowering apparatus to lift or lower the trace-tracking device may include a hydraulic cylinder, a direction-switching valve coupled to the hydraulic cylinder to switch a lifting mode or lowering mode of the hydraulic cylinder, a supply pipe between the direction-switching valve and an oil storage, and a hydraulic pump coupled to the supply pipe.

When the electric facility is damaged by the enemy attack, the hydraulic pump and hydraulic cylinder may not work. Further, when a pipe for supplying the hydraulic pressure to the hydraulic cylinder is abnormal, the hydraulic pressure may not be supplied to the hydraulic cylinder such that the hydraulic cylinder does not work. This may cause the trace-tracking device not to work well. This may lead to a lethal damage to our people.

Thus, in order to solve the problem, the present applicant disclose an automatic emergency lifting or lowering device for an operational deployment facility from a Korean Patent No. 10-1504988, which is incorporated by the reference herein. The previous invention provides an automatic emergency rising and falling device of an operational deployment facility to track a wheel track by an attack including animosity missiles, a shell, etc. or to rise and fall a wheel track device of the operational deployment facility for concealing the wheel track device. The present invention comprises: a plurality of hydraulic cylinders for rising and falling the wheel track device; a control box to set up a direction; an oil storage tank to store oil therein; a power unit for rising and falling the hydraulic cylinder; a hydraulic line for connecting the oil storage tank and the control box; a supply line to connect the control box and the hydraulic cylinder; a falling prevention valve installed on the supply line; and an accumulator connected to the hydraulic line.

However, the previous automatic emergency lifting or lowering device including the conventional one may have a following shortage: the hydraulic cylinder is employed to lift or lower the trace-tracking device, and, thus, the trace-tracking device may not be lifted up at a long distance.

### SUMMARY

From a consideration of the above situation, the present disclosure provides an automatic emergency lifting or lowering system for an operational deployment facility with a long lifting or lowering distance, which is not realized using the hydraulic cylinder. This may allow the trace-tracking device to lift up in a higher level to track a trace of the moving object accurately in a certain case.

In an aspect of the present disclosure, there is provided an automatic emergency lifting or lowering system for an operational deployment facility with a long hoisting distance, wherein the operational deployment facility has a platform and a trace-tracking device hidden in the platform, wherein the trace-tracking device is configured to track a trace of a moving object including a missile and a bomb, wherein the automatic emergency lifting or lowering system comprises; at least one hoist apparatus configured to lower or lift the trace-tracking device; and at least one hydraulic motor coupled to the hoist apparatus to drive the hoist apparatus in a lifting or lowering mode.

In one embodiment, the hoist apparatus comprises a winch coupled to the motor.

In one embodiment, the hoist apparatus comprises a lift structure to mount thereon the trace-tracking device.

In one embodiment, the lift structure has a guide roller installed at an outer side thereof, and the platform has a guide rail installed at an inner side thereof.

In one embodiment, the platform has a square shape, wherein the at least one hoist apparatus comprises four hoist apparatuses, and the at least one hydraulic motor comprises four hydraulic motors coupled to the four hoist apparatuses respectively, wherein the four hoist apparatuses are provided at four sides of the platform respectively.

In one embodiment, the platform has a square shape, and the at least one guide roller comprises four guide rollers and the at least one guide rail comprises four guide rails, wherein the four guide rails are provided at four sides of the platform respectively.

In one embodiment, the lift structure has at least one wire block to allow a hoisting wire to move around the wire block.

In one embodiment, the lift structure has a square shape, wherein the at least one wire block comprises four wire blocks, wherein the four wire blocks are provided at four corners of the lift structure.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 shows an overall circuit diagram of an automatic emergency lifting or lowering system for an operational deployment facility in one embodiment of the present disclosure.

FIG. 2 shows a schematic view of an essential portion of a hoist apparatus of an automatic emergency lifting or lowering system for an operational deployment facility in one embodiment of the present disclosure.

FIG. 3 shows a side view of a hoist apparatus of an automatic emergency lifting or lowering system for an operational deployment facility in one embodiment of the present disclosure.

FIG. 4 shows a top view of a platform and a hoist apparatus of an automatic emergency lifting or lowering system for an operational deployment facility in one embodiment of the present disclosure.

FIG. 5 shows a cross-sectional view taken in a line A-A in FIG. 4.

### DETAILED DESCRIPTIONS

Examples of various embodiments are illustrated in the accompanying drawings and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

Hereinafter, embodiments of the present disclosure will be described in details with reference to attached drawings.

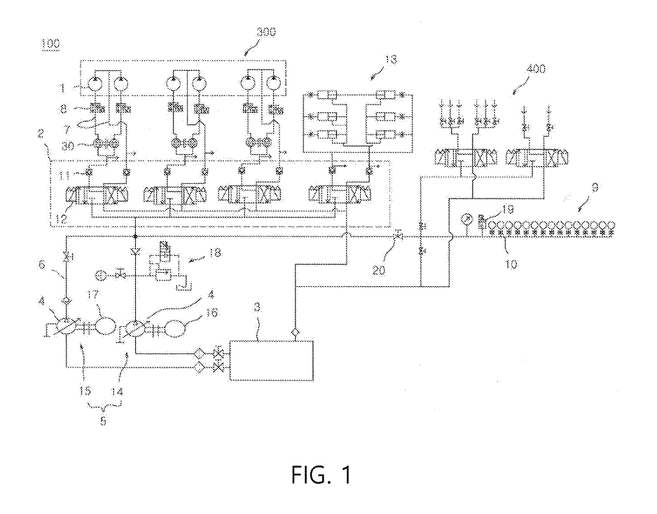

FIG. 1 shows an overall circuit diagram of an automatic emergency lifting or lowering system for an operational deployment facility in one embodiment of the present disclosure. The automatic emergency lifting or lowering system 100 for an operational deployment facility in one embodiment of the present disclosure may be configured to lift or lower a trace-tracking device (not shown) in order to track a missile, bomb, etc. and/or in order to hide the trace-tracking device. The automatic emergency lifting or lowering system 100 for an operational deployment facility in one embodiment of the present disclosure may be configured to lift or lower the trace-tracking device at a long distance.

As shown in FIG. 1, the automatic emergency lifting or lowering system 100 for an operational deployment facility in one embodiment of the present disclosure may include multiple hydraulic motors 1 configured to drive a hoist apparatus 300 for a trace-tracking device 200; a control box 2 configured to control a lifting or lowering direction of the hydraulic motor 1; an oil storage 3; a power unit 5 configured to allow a hydraulic pressure via a hydraulic pump 4 to the control box 2 to drive the hydraulic motors 1; a hydraulic pipe 6 to connect the power unit 5 to the oil storage 3 at one side and to connect the power unit 5 to the control box 2 at the other side; a supply pipe 7 to connect the control box 2 and the hydraulic motor 1 to each other; the hoist apparatus 300 coupled to the multiple hydraulic motors 1 to lift or lower the trace-tracking device 200; a fall-suppression valve 8 disposed at the supply pipe 7, and configured to suppress the trace-tracking device 200 from a rapid falling-down even when a supply of a hydraulic pressure to the hydraulic motor 1 stops during activation of the hoist apparatus 300; and multiple pressure-accumulators 9 coupled to the hydraulic pipe 6 and configured to enable the supply of the hydraulic pressure to the control box 2 when the power unit 5 undergoes a failure.

The pressure-accumulator 9 may be opened or closed via a valve 10. A number of the pressure-accumulators 9 may vary depending on a desired capacity. The pressure-accumulator 9 may be coupled to the hydraulic pipe 6. In this connection, details about the pressure-accumulator 9 are disclosed in Korean patent no. 10-1504988 assigned to the present applicant, which is incorporated by a reference herein.

The control box 2 may be coupled to the supply pipe 7 coupled to the hydraulic motor 1 at one side and, to the hydraulic pipe 6 coupled to the oil storage 3 at the other side. The control box 2 may be configured to control a lifting or lowering direction of the hydraulic motor 1. To this end, the control box 2 may include a pilot check valve 11 to control a hydraulic pressure at the supply pipe 7 side to supply the hydraulic pressure toward the hydraulic motor 1, and a direction-switching valve 12 at the hydraulic pipe 6 side to switch the lifting or lowering direction of the hydraulic motor 1. The direction-switching valve 12 may be coupled to a stopper 13 configured to stop the hydraulic motor 1 upon detection of an expected risk due to the operation of the hydraulic motor 1.

The power unit 5 may be installed at the hydraulic pipe 6 coupled to the oil storage 3 at one side and to the control box 2 at the other side. The power unit 5 may be configured to enable the hydraulic pressure via the hydraulic pump 4 to the control box 2 to drive the hydraulic motor 1 in a lifting or lowering mode. The power unit 5 may include an electric-type power unit 14 and an engine-type power unit 15.

The electric-type power unit 14 may use an electric-type motor 16 to drive the hydraulic pump 4. The engine-type power unit 15 may use an engine 17 to drive the hydraulic pump 4. In this connection, in a normal mode, the electric-type power unit 14 may be activated. In an emergency mode, for example, due to an electric outrage, the engine-type power unit 15 may be activated. The operation of the engine 17 may generate a sound, vibration, heat, etc. This may allow the enemy to locate the operational deployment facility. Thus, the enemy may attack the operational deployment facility using the thermal tracking missile. Normally, the electric-type power unit 14 is activated to drive the hydraulic motor 1.

At the hydraulic pipe 6 at the electric-type power unit 14 position, a hydraulic-pressure adjustment valve 18 may be provided to adjust the hydraulic pressure to be supplied to the hydraulic pump 4 between the electric-type power unit 14 and control box 2.

In this way, the power unit 5 may include the electric-type power unit 14 and engine-type power unit 15 such that in the normal mode, the electric-type power unit 14 is activated, and in the emergency mode due to the electric facility damage by the enemy's attack, the engine-type power unit 15 is activated to supply the hydraulic pressure via the hydraulic pump 4 to the hydraulic motor 1 to lift or lower the trace-tracking device 200. Thus, in the emergency mode due to the electric facility damage by the enemy's attack, the hydraulic motor 1 may be effected to lift or lower the trace-tracking device 200 which in turn may track the track of the missile, bomb, etc. of the enemy.

In one embodiment, in a normal mode, the electric-type power unit 14 may be activated. In an emergency mode, for example, due to an electric outrage, the engine-type power unit 15 may be activated. However, the present disclosure is not limited thereto. In an emergency mode, for example, due to an electric outrage, the pressure-accumulator 9 may be activated first to drive the hydraulic motor 1 in a lifting mode, and, thereafter, the engine-type power unit 15 may be activated to drive the hydraulic motor 1 in a lowering mode.

The pressure-accumulator 9 may be configured to accumulate the hydraulic pressure. Thus, in an emergency mode, for example, due to an electric outrage, the pressure-accumulator 9 may be configured to allow the hydraulic pressure to be supplied to the hydraulic motor 1 to lift or lower the trace-tracking device 200. For this, the pressure-accumulator 9 may be connected to the hydraulic pipe 6. The pressure-accumulator 9 may be plural. Each pressure-accumulator 9 may have a valve 10 installed thereat to allow the supply of the hydraulic pressure from each pressure-accumulator 9. The pressure-accumulator 9 may be coupled to the hydraulic pipe 6 via a further pipe having a pressure switch 19 and a main stop valve 20 installed thereat. The main stop valve 20 may be needed to discharge an inner fluid from the pressure-accumulator 9 to allow check of a nitrogen gas pressure therein.

The pressure-accumulator 9 may be configured to supply the hydraulic pressure to the hydraulic motor 1 at one time in an emergency mode, for example, due to an electric outrage, and, thereafter, the engine-type power unit 15 may be activated. This is due to the fact that it takes a certain amount of time to fill the pressure-accumulator 9 with the gas and, thus, the use thereof before a full gas charge level may lead to a damage of the pressure-accumulator 9.

The automatic emergency lifting or lowering system 100 for an operational deployment facility in one embodiment of the present disclosure may further an emergency manual device 400 coupled to the hydraulic pipe 6 at one side and to the oil storage 3 at the other side and configured to allow the manual supply of the hydraulic pressure to the hydraulic pressure hydraulic motor 1 when the power unit 5 and pressure-accumulator 9 both do not work.

The automatic emergency lifting or lowering system 100 for an operational deployment facility in one embodiment of the present disclosure may have the fall-suppression valve 8 and synchronous motor 30 at the supply pipe 7 between the hydraulic motor 1 and control box 2.

The fall-suppression valve 8 may be provided beneath the hydraulic motor 1 to interrupt the hydraulic pressure to the hydraulic motor 1 when the supply pipe 7 and/or hydraulic pipe 6 is damaged or abnormal. This may prevent the rapid lowering operation of the hoist apparatus 300. Thus, the trace-tracking device 200 may be suppressed from the damage.

The synchronous motor 14 may be provided at the supply pipe 6 disposed between the hydraulic motors 1 and control box 2 to allow the synchronous lowering or lifting between the multiple hydraulic motors 1 in an independent manner from the applied hydraulic pressure level. That is, when there may be pressure level variations between the multiple hydraulic motors 1, the synchronous motor 30 may allow the synchronous lowering or lifting between the multiple hydraulic motors 1 in an independent manner from the applied hydraulic pressure level.

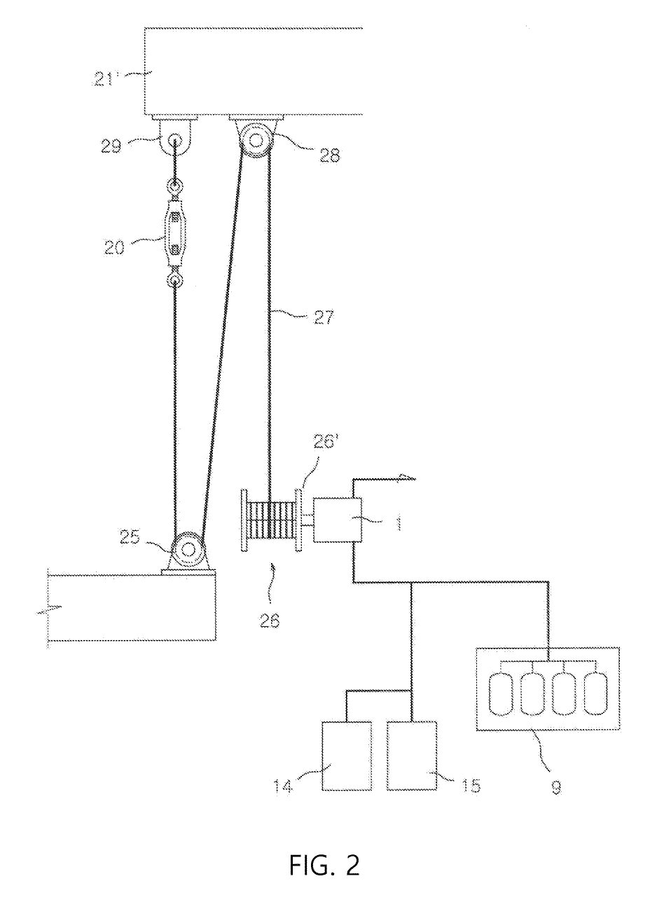

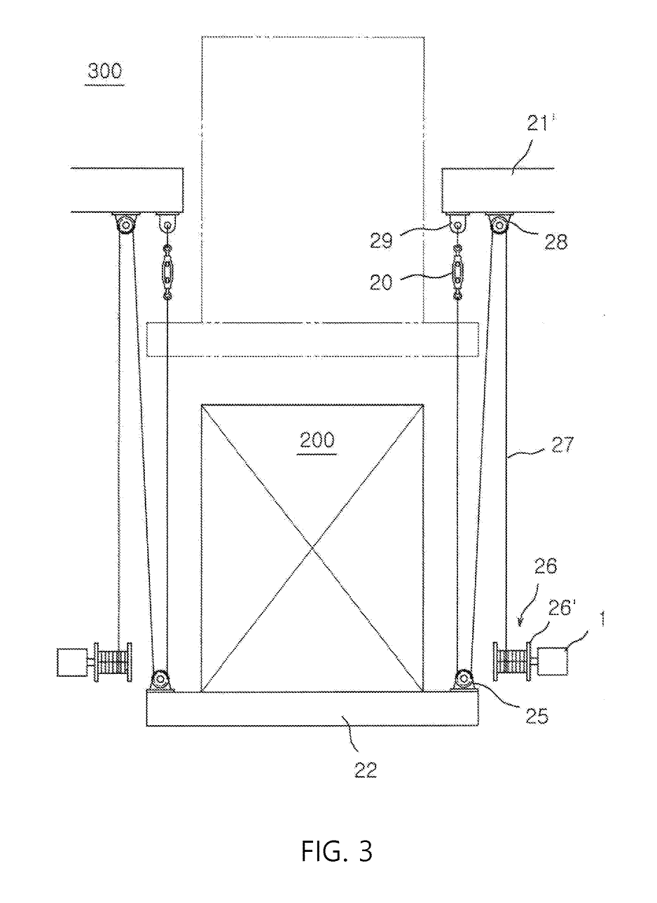

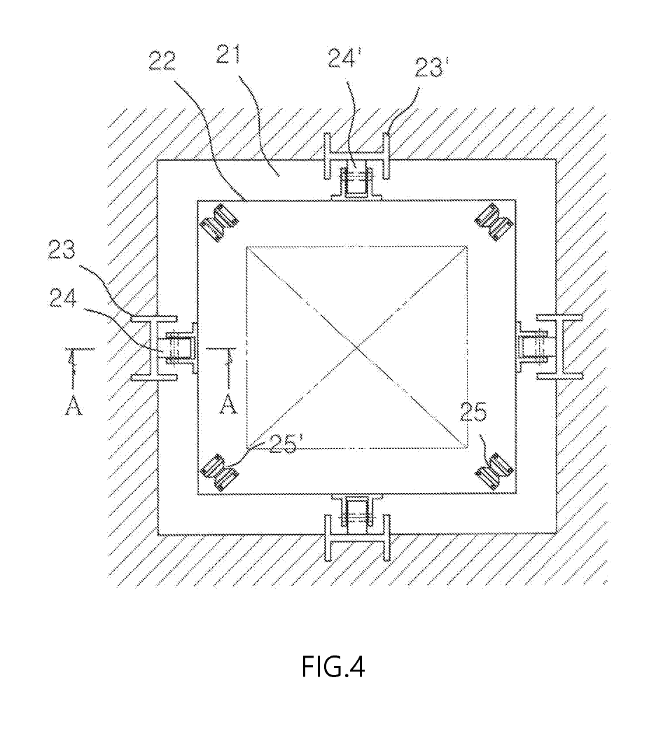

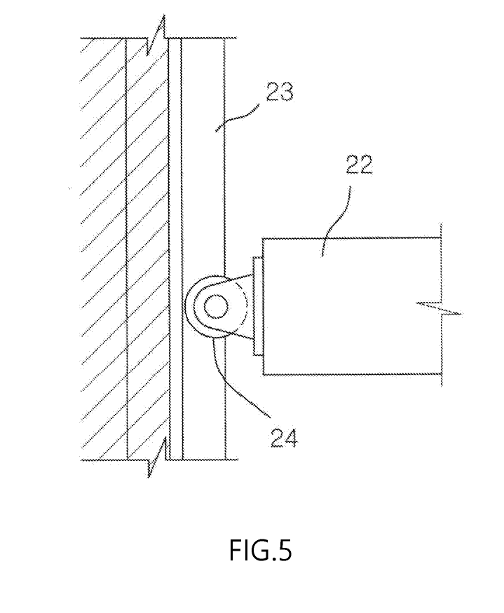

FIG. 2 shows a schematic view of an essential portion of a hoist apparatus 300 of an automatic emergency lifting or lowering system 100 for an operational deployment facility in one embodiment of the present disclosure. FIG. 3 shows a side view of a hoist apparatus 300 of an automatic emergency lifting or lowering system for an operational deployment facility in one embodiment of the present disclosure. FIG. 4 shows a top view of a platform and a hoist apparatus 300 of an automatic emergency lifting or lowering system 100 for an operational deployment facility in one embodiment of the present disclosure. FIG. 5 shows a cross-sectional view taken in a line A-A in FIG. 4.

The hoist apparatus 300 may include a lift structure 22 disposed in a platform 21 hiding therein the trace-tracking device 200. The lift structure 22 may be configured to lift or lower the trace-tracking device 200 mounted thereon. The hoist apparatus 300 may include guide rails 23 and 23′ provided on an inner side wall of the platform 21 and guide rollers 24 and 24′ provided on the lift structure 22 to run along the guide rails 23 and 23′ respectively. The hoist apparatus 300 may include wire blocks 25 and 25′ mounted on four top corners of the lift structure 22, and a winch 26 driven by the hydraulic motor 1. The hoist apparatus 300 may include chain blocks 28 fixed to the top structure 21′ of the platform 21 and facing away the winching drum 26. Hoisting wires 27 may wind the winch 26 and the chain blocks 28. The hoist apparatus 300 may include lugs 29 fixed to the top structure 21′ of the platform 21 and facing away the wire blocks 25 and 25′. The hoisting wires 27 may be fixed to the lugs 29 at one end of each wire. The hoisting wires 27 may run from the winch 26 via the chain blocks 28 and via the wire blocks 25 and then may be fixed to the lugs 29. In one example, the lugs 29 may be provided on four corners of a bottom of the top structure 21′ of the platform 21. The chain blocks 28 may be adjacent to the lugs 29 more inwardly respectively and may be provided on four corners of a bottom of the top structure 21′ of the platform 21. Each hoisting wire 27 may be wound around each winch 26. The winches 26 each may be coupled to each motor 1. Thus, via rolling or unwinding of each of the winches 26, the trace-tracking device 200 mounted on the lift structure 22 may be lifted up or be lowered down freely. A turnbuckle 20 may be coupled to the hoisting wire 17 coupled to the lug 19 to adjust the tension of the hoisting wire 27.

For an operation of the automatic emergency lifting or lowering system 100, in a normal mode, the electric-type motor 16 of the electric-type power unit 14 may be activated to allow the hydraulic pump 4 to supply the hydraulic pressure to the control box 2, and, then, the direction-switching valve 12 of the control box 2 may determine the lifting or lowering direction and, thus, correspondingly, the hydraulic motor 1 may be activated to drive the hoist apparatus 300 to allow the winch 26 to the hoisting wire 27 to be wound or unwound around the bobbin 26′ to allow the lift structure 22 to be lifted or lowered.

When the winch 26 may allow the hoisting wire 27 to be wound around the bobbin 26′, the trace-tracking device 200 may lift. When the hoisting wire 27 winds the bobbin 26′ of the winch 26, the hoisting wire may move around the chain block 28 at the bottom of the top structure 21′ of the platform 21. Since the lug 29 to which one end of the hoisting wire 27 is fixed is secured to the top structure 21′, the hoisting wire 27 may move around the chain blocks 28 and 25 to lift the lift structure 22 up to allow the trace-tracking device 200 to move up out of the platform 21 to track a trace of the moving missile or bomb, etc.

To the contrary, when the winch 26 may allow the hoisting wire 27 to be unwound around the bobbin 26′, the trace-tracking device 200 may be lowered. When the hoisting wire 27 unwinds the bobbin 26′ of the winch 26, the hoisting wire may move around the chain block 28 at the bottom of the top structure 21′ of the platform 21 in the opposite direction. Since the lug 29 to which one end of the hoisting wire 27 is fixed is secured to the top structure 21′, the hoisting wire 27 may move around the chain blocks 28 and 25 in the opposite direction to lower the lift structure 22 down to allow the trace-tracking device 200 to move down into the platform 21 to be hidden in the platform 21.

In this connection, the guide rails 23 and 23′ may be provided on the inner side wall of the platform 21 to guide the lift structure 22. Correspondingly, the guide rollers 24 and 24′ may be provided on the outer side face of the lift structure 22 to run along the guide rollers 24 and 24′ respectively. This may lead to the smooth ascending or descending operation of the lift structure 22.

The turnbuckle 20 may be coupled to the hoisting wire 17 coupled to the lug 19 to adjust the tension of the hoisting wire 27. This may allow the ascending or descending operation of the lift structure 22 to be efficient.

In one embodiment, the platform 21 has a square shape, wherein the at least one hoist apparatus 300 comprises four hoist apparatuses 300, and the at least one hydraulic motor 1 comprises four hydraulic motors 1 coupled to the four hoist apparatuses respectively, wherein the four hoist apparatuses are provided at four sides of the platform 21 respectively.

In one embodiment, the platform has a square shape, and the at least one guide roller 24 comprises four guide rollers and the at least one guide rail 23 comprises four guide rails, wherein the four guide rails are provided at four sides of the platform respectively.

In one embodiment, the lift structure 22 has at least one wire block to allow the hoisting wire to move around the wire block 25.

In one embodiment, the lift structure 22 has a square shape, wherein the at least one wire block comprises four wire blocks 25, wherein the four wire blocks are provided at four corners of the lift structure.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. An automatic emergency lifting or lowering system for an operational deployment facility with a long hoisting distance, wherein the operational deployment facility has a platform and a trace-tracking device hidden in the platform, wherein the trace-tracking device is configured to track a trace of a moving object including a missile and a bomb, wherein the automatic emergency lifting or lowering system comprises;
at least one hoist apparatus configured to lower or lift the trace-tracking device; and
at least one hydraulic motor coupled to the hoist apparatus to drive the hoist apparatus in a lifting or lowering mode.

2. The system of the claim 1, wherein the hoist apparatus comprises a winch coupled to the motor.

3. The system of claim 1, wherein the hoist apparatus comprises a lift structure to mount thereon the trace-tracking device.

4. The system of claim 3, wherein the lift structure has at least one guide roller installed at an outer side thereof, and the platform has at least one guide rail installed at an inner side thereof, along which the at least one guide roller runs.

5. The system of claim 1, wherein the platform has a square shape, wherein the at least one hoist apparatus comprises four hoist apparatuses, and the at least one hydraulic motor comprises four hydraulic motors coupled to the four hoist apparatuses respectively, wherein the four hoist apparatuses are provided at four sides of the platform respectively.

6. The system of claim 4, wherein the platform has a square shape, and the at least one guide roller comprises four guide rollers and the at least one guide rail comprises four guide rails, wherein the four guide rails are provided at four sides of the platform respectively.

7. The system of claim 3, wherein the lift structure has at least one wire block to allow a hoisting wire to move around the wire block.

8. The system of claim 7, wherein the lift structure has a square shape, wherein the at least one wire block comprises four wire blocks, wherein the four wire blocks are provided at four corners of the lift structure.
